(19) United States
(12) Patent Application Publication
(10) Pub. No.: US 2006/0152359 A1
(43) Pub. Date: Jul. 13, 2006

(54) "Mayah project" - child recovery system

(76) Inventor: James Anthony Jimason, Temple Hills, MD (US)

Correspondence Address: JAMES A. JIMASON, 2027 SOUTH ANVIL LANE, TEMPLE HILLS, MD, 20748, US

(21) Appl. No.: 11/021,084

(22) Filed: Dec. 27, 2004

(51) Int. Cl. G08B 1/08

(52) U.S. Cl. 340/539.15; 340/573.4

(57) ABSTRACT

This invention is a unique system designed to give peace of mind and security to parents against child abduction. This invention uses two simple devices that already exist. These two devices would be combined and placed in objects that will not appear to anyone as tracking devices. The first device is the LoJack Transceiver, used to recover stolen cars. The second device is the HomeAgain I.D. chip, used to identify missing pets. These combined devices would be placed in four objects. Such as, a child's backpack, tennis shoe, lunch box, and a working wristwatch. Hiding these devices provides safety for the wearer against a would be abductor, and increase the effectiveness of the invention. This invention does not require surgery or implants of any kind. Neither does it invade a child's privacy because it is not a “monitoring device.”

The Mayah Project—Child Recovery System involves combining two components or parts for the sole purpose of locating and identifying a lost or abducted child. The Mayah Project—Child Recovery System will serve as a system of protection for children against being lost or abducted.

The first and main component or part is the LoJack Car Recovery System. The LoJack Car Recovery System uses a small radio frequency transceiver hidden in several places in a car. Each system has a unique code that is tied into the Vehicle Identification Number. This same technology can be placed within the items listed below (see paragraphs 0005-0008). When a car is reported stolen, the LoJack system is activated; this emits an inaudible signal that can be tracked by police. This same process can be used to track a lost or abducted child.

The second component or part is the HomeAgain I.D. microchip. The HomeAgain I.D. microchip is about the size of a grain of rice (about 12 mm). This microchip has information about the pet and owner loaded into it. The microchip is then inserted under the skin of the pet. The microchip emits a radio frequency when activated by a scanner. The HomeAgain I.D. microchip does not use batteries or an internal energy source. The microchip will last the life of the pet (in this case a child). The microchip remains inactive until scanned. The scanner gives the microchip power to transmit the necessary information about the pet. This same device can include information on a child and parent or parents. However, instead of placing the microchip under the skin of a child, it would be placed in the items listed below (see paragraphs 0005-0008).

The next four items describe how the above two components or parts will be concealed or packaged for sale to a parent or parents as a Child Recovery System. The concealment of the above two components in the items listed below (see paragraphs 0005-0008) will provide security to the wearer in the event he or she is abducted. No one will know that the items worn by the child has the ability to be tracked. This system does not monitor a child's every move nor invades their privacy.

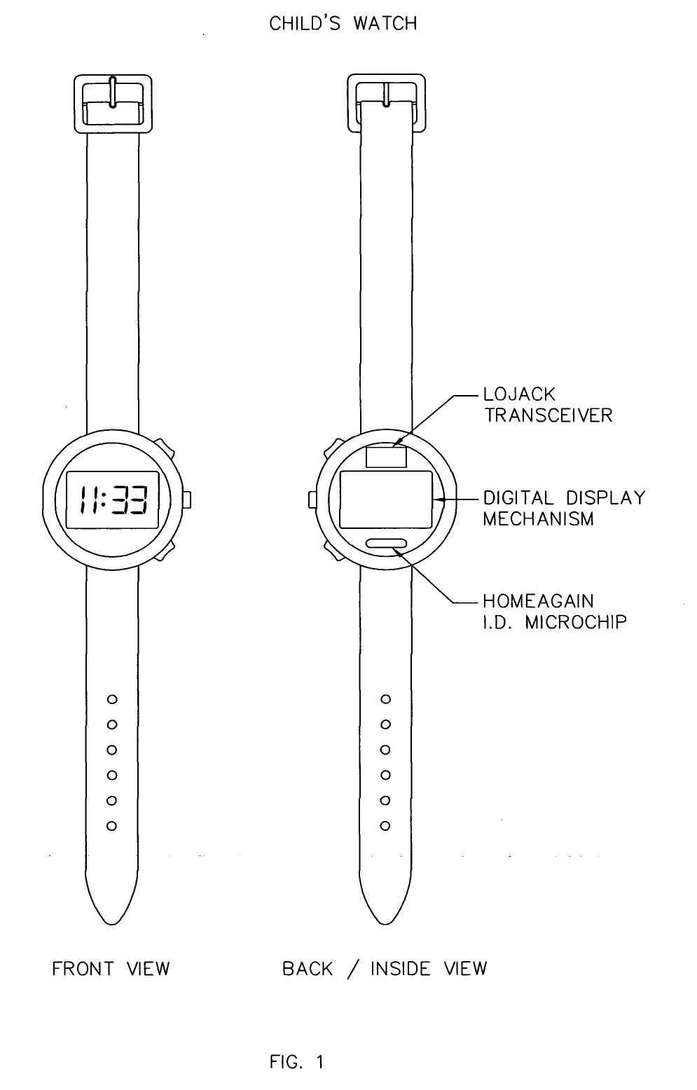

The first item is a child's watch. A child's watch should be enlarged to accommodate both the LoJack transceiver and the HomeAgain I.D. microchip. The watch would be a fully functional digital watch that tells time (see FIG. 1 on page 4).

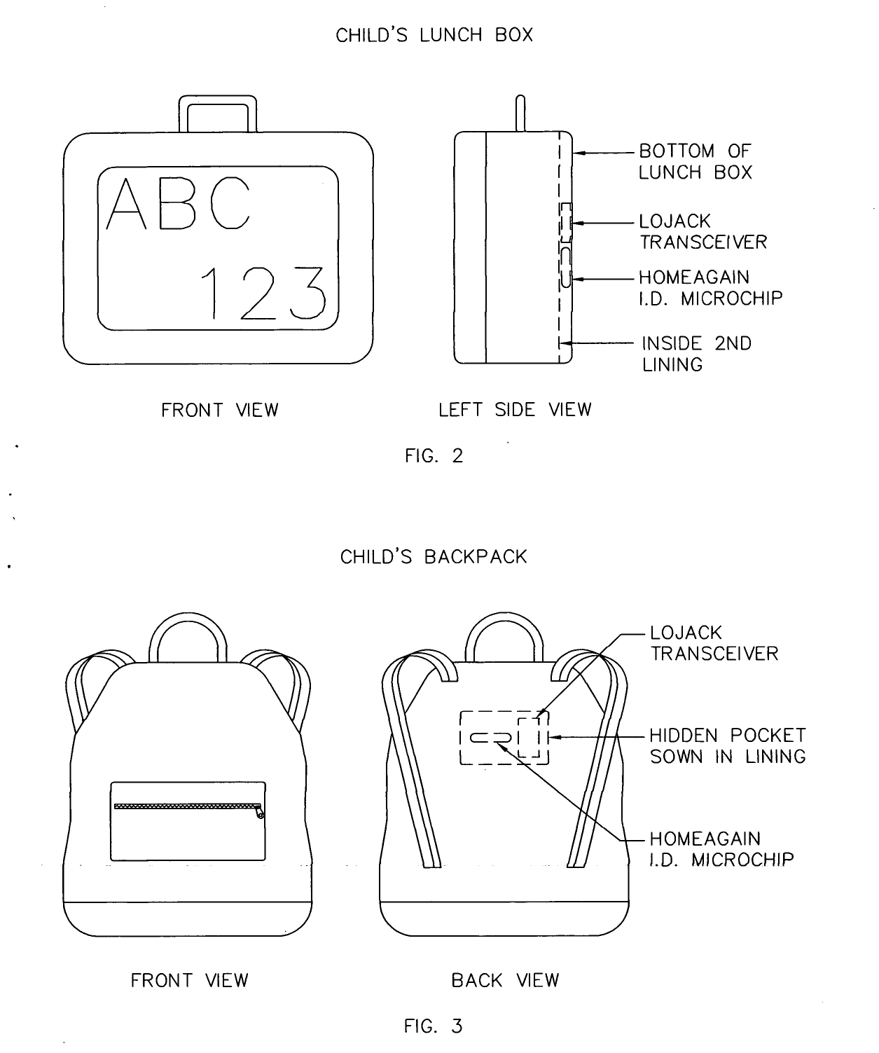

The second item is a child's lunch box. A child's lunch box should be modified by adding a second layer in the bottom. Place the LoJack transceiver and HomeAgain I.D. microchip between the bottom and second layer of the lunch box (see FIG. 2 on page 5).

The third item is a child's backpack. A small pocket should on the inside lining of the backpack where the LoJack transceiver and HomeAgain I.D. microchip will be placed. The pocket should be located on the side that rests against the back of a child when carried on his or her shoulders. After the items are placed within the pocket, it should be sown closed (see FIG. 3 on page 5).

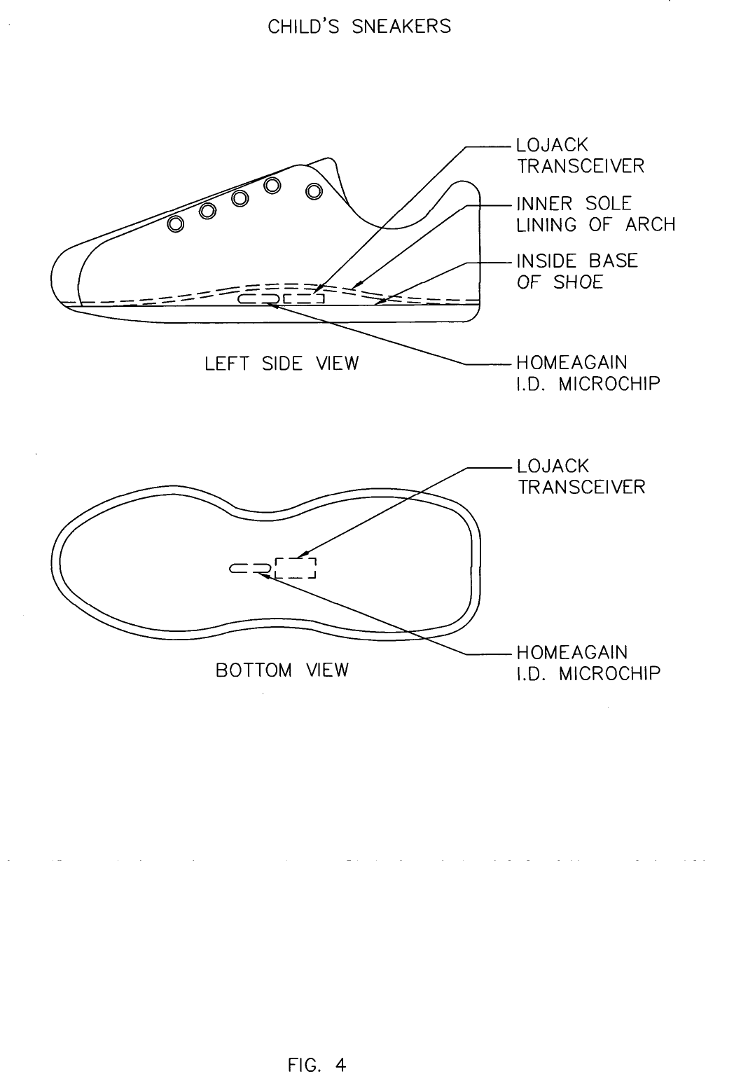

The fourth item is children's sneakers. The LoJack transceiver and the HomeAgain I.D. microchip should be placed between the insole padding and bottom of the shoes in the arch area. This will lessen impact from walking, running, and jumping (see FIG. 4 on page 6).

How it all works. Once the LoJack transceiver and the HomeAgain I.D. microchip are placed in the above items (see paragraphs 0005-0008), they will be sold to a parent or parents only. A store (preferably LoJack) will have all four items for sale. Once these items are purchased, basic information will be gathered about the child or children and parent or parents. The information gathered would be as followed: the child's name, gender, age, race, parent or parents' names, contact numbers (home, work and cell), and home address. The information about the child and parent or parents will be loaded into the HomeAgain I.D. microchip and kept in a computer. This information will be retrieved only in the event a child is lost or abducted.

In the event a child is lost or abducted, the LoJack tracking system will be activated. The relationship that LoJack already has with state and local officials will be utilized to find the missing child. Once the child is found, a scan will be done, like with a lost pet, to confirm the child's identity and parent or parents' contact information. The parent or parents are then notified that their child has been found. The parent or parents are reunited with their child.

Information on companies needed and suggested for The Mayah Project—Child Recovery System. LoJack, www.lojack.com, 1-800-456-5225. HomeAgain I.D., www.homeagainid.com, 1-800-521-5767. Timex, www.timex.com, custserv@timex.com (email), 1-800-448-4639. JanSport, www.jansport.com, 1-800-426-9227 or www.campmor.com, 1-800-525-4784. Lunch Boxes, www.lunchboxes.com, info@lunchboxes.com (email), and 323-660-9279. Nike, www.nike.com, 1-800-806-6453, or 1-800-640-8007 (investor relations).

I claim the following as my invention:

1. The combining of both the LoJack Car Recovery System and the HomeAgain I.D. Microchip, for the sole purpose of locating and identifying a lost or abducted child.

2. The packaging of item #1 in the form of a child's watch, for the sole purpose of selling to a parent or parents as a Child Recover System.

3. The packaging of item #1 in the form of a child's backpack, for the sole purpose of selling to a parent or parents as a Child Recovery System.

4. The packaging of item #1 in the form of a child's lunch box, for the sole purpose of selling to a parent or parents as a Child Recovery System.

5. The packaging of item #1 in the form of a child's sneakers (tennis shoes), for the sole purpose of selling to a parent or parents as a Child Recovery System.
